(19) United States
(12) Patent Application Publication
(10) Pub. No.: US 2016/0087745 A1
(43) Pub. Date: Mar. 24, 2016

(54) SUPPORTING AN ADD-ON REMOTE UNIT (RU) IN AN OPTICAL FIBER-BASED DISTRIBUTED ANTENNA SYSTEM (DAS) OVER AN EXISTING OPTICAL FIBER COMMUNICATIONS MEDIUM USING WAVELENGTH DIVISION MULTIPLEXING (WDM)

(71) Applicant: CORNING OPTICAL COMMUNICATIONS WIRELESS LTD, AIRPORT CITY (IL)

(72) Inventors: Yury Abramov, Petah Tikva (IL); Nissim Atias, Ra'anana (IL); Dror Harel, Hod Hasharon (IL); Hillel Akiva Hendler, Jerusalem (IL); Gavriel Magnezi, Givat Shemuel (IL); Yuval Zinger, Painted Post, NY (US)

(21) Appl. No.: 14/493,966

(22) Filed: Sep. 23, 2014

(51) Int. Cl. H04J 14/02; H04B 10/2575

(52) U.S. Cl. CPC H04J 14/021; H04J 14/0254; H04B 10/25753; H04W 88/085

(57) ABSTRACT

Embodiments disclosed in the detailed description include supporting an add-on remote unit(s) (RU) in an optical fiber-based distributed antenna system (DAS) over existing optical fiber communication medium using wavelength division multiplexing (WDM). An existing DAS comprises at least one existing head end equipment (HEE) communicatively coupled to a plurality of existing RUs through an optical fiber communication medium. In aspects disclosed herein, an add-on RU is added to the existing DAS to support additional wireless communications. No new optical fibers are required to be deployed to support communications to the add-on RU in the DAS. Instead, the DAS is configured to support the add-on RU through the existing optical fiber communication medium using WDM. Thus, the add-on RU can be added to the existing DAS without adding new optical fibers, thus leading to reduced service disruptions and deployment costs.

### BACKGROUND

The disclosure relates generally to distribution of data (e.g., digital data services and radio-frequency communications services) in a distributed antenna system (DAS) and more particularly to supporting an add-on remote unit(s) (RU) for new or additional communications services over an existing optical fiber communications medium using wavelength division multiplexing (WDM).

Wireless customers are demanding digital data services, such as streaming video signals. Concurrently, some wireless customers use their wireless devices in areas that are poorly served by conventional cellular networks, such as inside certain buildings or areas where there is little cellular coverage. One response to the intersection of these two concerns has been the use of distributed antenna systems (DASs). DASs can be particularly useful to be deployed inside buildings or other indoor environments where client devices may not otherwise be able to effectively receive radio-frequency (RF) signals from a source. DASs include remote units (also referred to as “remote antenna units”) configured to receive and wirelessly transmit wireless communications signals to client devices in antenna range of the remote units. Such DASs may use Wireless Fidelity (WiFi) or wireless local area networks (WLANs), as examples, to provide digital data services.

A typical DAS comprises head end equipment (HEE) communicatively coupled to a plurality of remote units (RUs). The HEE connects to a variety of wireless services, such as wideband code division multiple access (WCDMA), long term evolution (LTE), and WLAN communications services. A plurality of RUs is deployed inside buildings or other indoor environments to form RF antenna coverage areas. Each of the RUs contain or is configured to couple to one or more antennas configured to support desired frequency(ies) or polarization to redistribute the variety of wireless services to client devices in the respective RF antenna coverage area. The DAS may employ optical fiber as an optical fiber-based DAS to support reliable downlink distribution of the variety of wireless communications services from the HEE to the RUs and vice versa for uplink distribution. Each RU is communicatively coupled to the HEE through an optical fiber pair—one downlink optical fiber provided for downlink communications and one uplink optical fiber provided for uplink communications. Optical fiber enjoys the benefit of large bandwidth capability with low noise over conductor-based communications medium. However, fast advancement of wireless technologies and growing user demand for new or additional wireless communications services may exceed the capabilities of the existing, installed RUs in the optical fiber-based DAS even if the installed optical fiber communications medium has additional bandwidth availability to support such new or additional wireless communications services. As a result, new RUs may need to be added to the installed optical-fiber based DAS, but additional optical fiber must be provided to provide optical communications between the new RUs and the HEE.

No admission is made that any reference cited herein constitutes prior art. Applicant expressly reserves the right to challenge the accuracy and pertinency of any cited documents.

### SUMMARY

Embodiments disclosed in the detailed description include supporting an add-on remote unit(s) (RU) in an optical fiber-based distributed antenna system (DAS) over existing optical fiber communications medium using wavelength division multiplexing (WDM). An existing DAS comprises at least one existing head end equipment (HEE) communicatively coupled to a plurality of existing RUs through an optical fiber communication medium. The HEE is configured to distribute downlink communications signals over existing downlink optical fiber to the plurality of existing RUs. The plurality of RUs is configured to distribute uplink communications signals over existing uplink optical fiber to the HEE. In aspects disclosed herein, an add-on RU is added to the existing DAS to support additional wireless communications. No new optical fibers are required to be deployed to support communications to the add-on RU in the DAS. Instead, the DAS is configured to support the add-on RU through the existing optical fiber communications medium using WDM. By supporting the add-on RU in the DAS over the existing optical fiber communications medium supporting the existing RUs using WDM, the add-on RU can be added to the existing DAS without adding new optical fibers, thus leading to reduced service disruptions and deployment costs.

One embodiment of the disclosure relates to an upgraded HEE in an optical fiber-based DAS. The upgraded HEE comprises an existing downlink communications signal path, an add-on downlink communications signal path, and a HEE wavelength division multiplexer. The existing downlink communications signal path is configured to receive and convert at least one first downlink radio frequency (RF) communications signal into at least one first downlink optical signal. The add-on downlink communications signal path is configured to receive and convert at least one second downlink RF communications signal, which is different from the at least one first downlink RF communications signal, into at least one second downlink optical signal. The HEE wavelength division multiplexer is coupled to a downlink optical fiber. The HEE wavelength division multiplexer is configured to receive the at least one first downlink optical signal from the existing downlink communications signal path via at least one first downlink optical signal interface. The HEE wavelength division multiplexer is also configured to receive the at least one second downlink optical signal from the add-on downlink communications signal path via at least one second downlink optical signal interface. The HEE wavelength division multiplexer is also configured to wavelength division multiplex (WDM) the at least one first downlink optical signal and the at least one second downlink optical signal and generate a downlink WDM optical signal. The HEE wavelength division multiplexer is also configured to provide the downlink WDM optical signal to the downlink optical fiber coupled to a RU wavelength division de-multiplexer in at least one RU.

An additional embodiment of the disclosure relates to an upgraded RU system in an optical fiber-based DAS. The upgraded RU system comprises an existing RU downlink communications signal path. The existing RU downlink communications signal path is configured to receive and convert at least one first downlink optical signal into at least one first downlink electrical RF signal. The upgraded RU system also comprises an add-on RU downlink communications signal path. The add-on RU downlink communications signal path is configured to receive and convert at least one second downlink optical signal into at least one second downlink electrical RF signal, which is different from the at least one first downlink electrical RF signal. The upgraded RU system also comprises a RU wavelength division de-multiplexer. The RU wavelength division de-multiplexer is coupled to a downlink optical fiber. The RU wavelength division de-multiplexer is configured to receive a downlink wavelength division multiplexing (WDM) optical signal from the downlink optical fiber coupled to a HEE wavelength division multiplexer in at least one HEE. The RU wavelength division de-multiplexer is also configured to wavelength division de-multiplex the downlink WDM optical signal and generate the at least one first downlink optical signal and the at least one second downlink optical signal. The RU wavelength division de-multiplexer is also configured to provide the at least one first downlink optical signal to the existing RU downlink communications signal path via at least one first RU downlink optical signal interface. The RU wavelength division de-multiplexer is also configured to provide the at least one second downlink optical signal to the add-on RU downlink communications signal path via at least one second RU downlink optical signal interface.

An additional embodiment of the disclosure relates to an upgraded optical fiber-based DAS. The upgraded optical fiber-based DAS comprises a HEE, a RU system, at least one downlink optical fiber, and at least one uplink optical fiber. The HEE comprises at least one existing radio interface module (RIM), at least one existing optical interface module (OIM) coupled to the at least one existing RIM. The HEE also comprises at least one add-on RIM and at least one add-on OIM coupled to the at least one add-on RIM. The HEE also comprises a HEE wavelength division multiplexing/de-multiplexing (mux/demux) circuit coupled to the at least one existing OIM and the at least one add-on OIM. The HEE wavelength division mux/demux circuit further comprises a HEE wavelength division multiplexer and a HEE wavelength division de-multiplexer. The RU system comprises at least one existing RU, at least one add-on RU, and a RU wavelength division mux/demux circuit coupled to the at least one existing RU and the at least one add-on RU. The RU wavelength division mux/demux circuit further comprises a RU wavelength division multiplexer and a RU wavelength division de-multiplexer. The at least one downlink optical fiber connects the HEE wavelength division multiplexer to the RU wavelength division de-multiplexer. The at least one uplink optical fiber connects the RU wavelength division multiplexer to the HEE wavelength division de-multiplexer.

An additional embodiment of the disclosure relates to a method for adding an add-on RU in an existing DAS. The method comprises upgrading an existing RU system in the existing DAS. The method for upgrading an existing RU system in the existing DAS comprises providing an add-on RU. The add-on RU is configured to receive an add-on downlink wireless communications signal for an add-on wireless communications service over an existing downlink optical fiber coupled to an existing RU, wherein the existing RU is configured to receive an existing downlink wireless communications signal for an existing wireless communications service over the existing downlink optical fiber. The add-on RU is also configured to provide an add-on uplink wireless communications signal for the add-on wireless communications service over an existing uplink optical fiber coupled to the existing RU, wherein the existing RU is configured to provide an existing uplink wireless communications signal for the existing wireless communications service over the existing uplink optical fiber. The method for upgrading an existing RU system in the existing DAS further comprises disconnecting the existing downlink optical fiber and the existing uplink optical fiber from the existing RU, installing a RU wavelength division multiplexing/de-multiplexing (mux/demux) circuit, connecting the add-on RU and the existing RU to the RU wavelength division mux/demux circuit, and connecting the RU wavelength division mux/demux circuit to the existing downlink optical fiber and the existing uplink optical fiber. The method also comprises and upgrading an existing HEE in the existing DAS. The method for upgrading an existing HEE in the existing DAS comprises providing an add-on RIM. The add-on RIM is configured to receive the add-on downlink wireless communications signal from an add-on wireless communications service provider for the add-on wireless communications service. The add-on RIM is also configured to provide the add-on uplink wireless communications signal to the add-on wireless communications service provider for the add-on wireless communications service. The method for upgrading the existing HEE in the existing DAS further comprises providing an add-on OIM and connecting the add-on OIM to the add-on RIM. The method for upgrading the existing HEE in the existing DAS further comprises steps of identifying an existing OIM coupled to the existing downlink optical fiber and the existing uplink optical fiber, wherein the existing downlink optical fiber and the existing uplink optical fiber connect to the RU wavelength division mux/demux circuit. The method for upgrading the existing HEE in the existing DAS further comprises disconnecting the existing OIM from the existing downlink optical fiber and the existing uplink optical fiber, installing a HEE wavelength division mux/demux circuit, connecting the add-on OIM and the existing OIM to the HEE wavelength division mux/demux circuit, and connecting the HEE wavelength division mux/demux circuit to the existing downlink optical fiber and the existing uplink optical fiber.

Additional features will be set forth in the detailed description, and in part will be readily apparent to those skilled in the art from the description or recognized by practicing the embodiments as described in the written description, claims, and the drawings.

The foregoing general description and the detailed description are merely exemplary, and are intended to provide an overview to understand the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary distributed antenna system (DAS);

FIG. 2A is a schematic diagram of an exemplary optical fiber-based DAS configured to distribute wireless communications services to a plurality of remote units (RUs);

FIG. 2B is an exemplary schematic diagram illustrating a simplified version of the optical fiber-based DAS in FIG. 2A showing the head end equipment (HEE) communicatively coupled to a RU over an existing optical fiber communication medium;

FIG. 3 is a schematic diagram of an exemplary upgraded optical fiber-based DAS of FIG. 2B configured to support an add-on RU over the existing optical fiber communication medium using wave division multiplexing (WDM);

FIG. 4 is a schematic diagram of an exemplary configuration of an existing RU system in an upgraded optical fiber-based DAS for supporting an add-on RU;

FIG. 5 is a schematic diagram of an exemplary add-on RU that shares an antenna with an existing RU in an upgraded optical-fiber based DAS;

FIG. 6 is a schematic diagram of another exemplary upgraded optical fiber-based DAS configured to support an add-on RU over existing optical fiber communication medium using a wavelength division multiplexing/de-multiplexing circuit integrated or packaged with the add-on RU in a RU system;

FIG. 7 is a schematic diagram of the combined add-on RU of FIG. 6 illustrating additional detail of the add-on RU provided therein sharing an antenna with an existing RU;

FIG. 8 is a flowchart of an exemplary configuration process for upgrading an optical fiber-based DAS to support an add-on RU over the existing optical fiber communication medium using WDM; and

FIG. 9 is a partially schematic cut-away diagram of an exemplary building infrastructure in which the upgraded optical fiber-based DAS in FIGS. 3 and 4 can be employed.

### DETAILED DESCRIPTION

Various embodiments will be further clarified by the following examples.

Embodiments disclosed in the detailed description include supporting an add-on remote unit(s) (RU) in an optical fiber-based distributed antenna system (DAS) over existing optical fiber communications medium using wavelength division multiplexing (WDM). An existing DAS comprises at least one existing head end equipment (HEE) communicatively coupled to a plurality of existing RUs through an optical fiber communication medium. The HEE is configured to distribute downlink communications signals over existing downlink optical fiber to the plurality of existing RUs. The plurality of RUs is configured to distribute uplink communications signals over existing uplink optical fiber to the HEE. In aspects disclosed herein, an add-on RU is added to the existing DAS to support additional wireless communications. No new optical fibers are required to be deployed to support communications to the add-on RU in the DAS. Instead, the DAS is configured to support the add-on RU through the existing optical fiber communications medium using WDM. By supporting the add-on RU in the DAS over the existing optical fiber communications medium supporting the existing RUs using WDM, the add-on RU can be added to the existing DAS without adding new optical fibers, thus leading to reduced service disruptions and deployment costs.

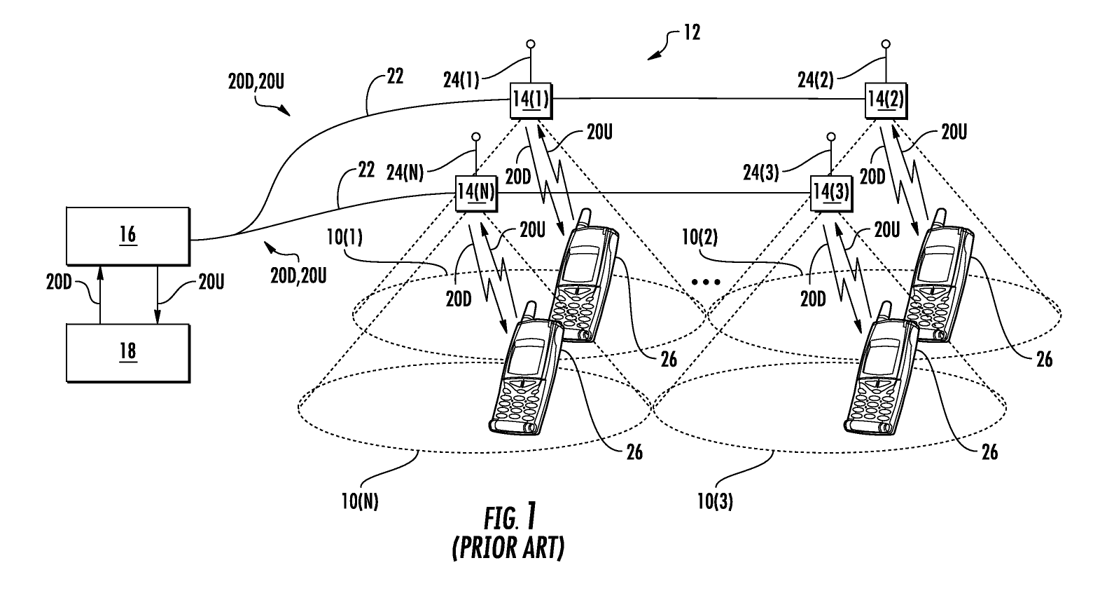

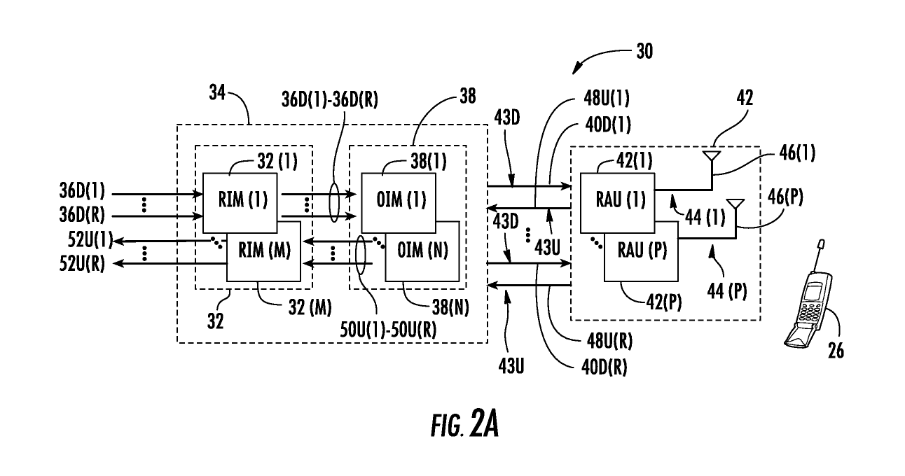

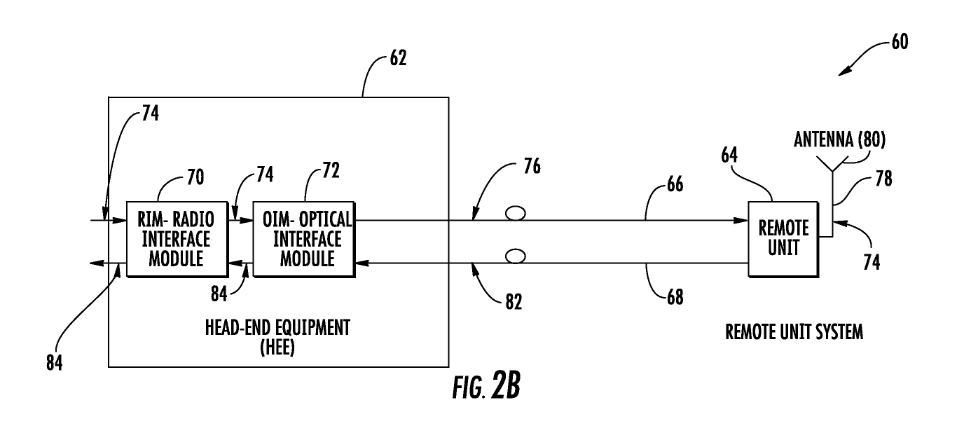

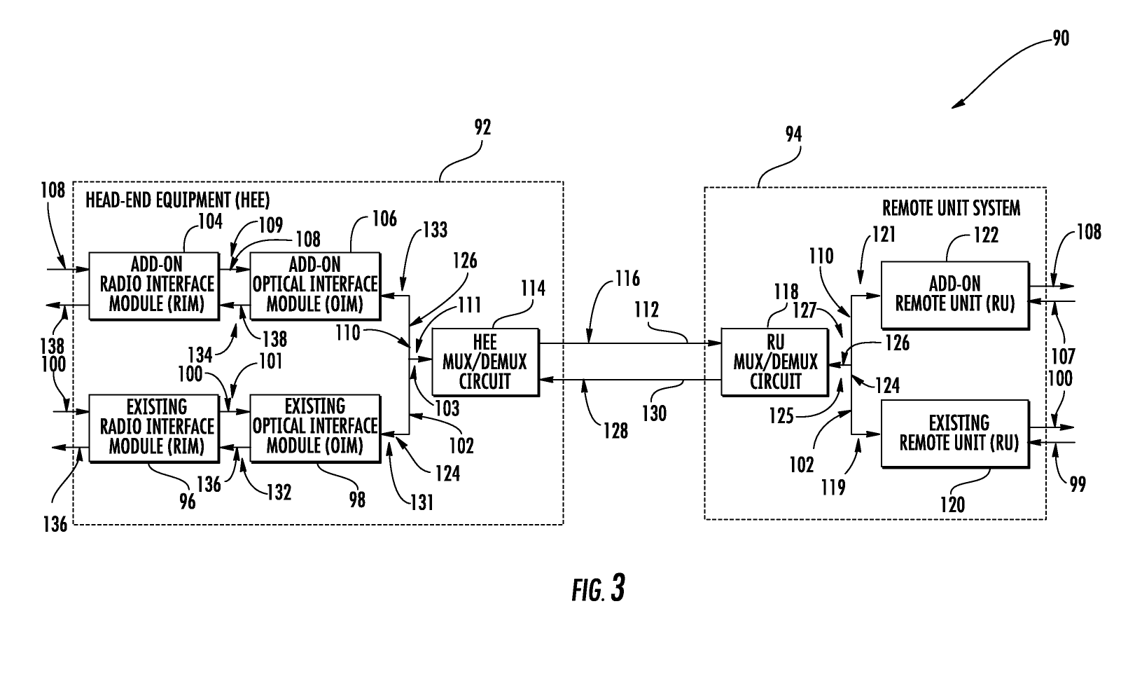

Before discussing aspects of supporting add-on RUs in an optical fiber-based DAS over existing optical fiber communication medium using WDM according to the present disclosure, a discussion of an exemplary existing optical fiber-based DAS that employs optical fiber communication medium to support wireless communications services to a plurality of RUs is first provided with references to FIGS. 1-2B. The discussion of specific exemplary aspects of supporting the add-on RU in the DAS over existing optical fiber communication medium using WDM begins with reference to FIG. 3.

FIG. 1 illustrates distribution of communications services to coverage areas 10(1)-10(N) of a DAS 12, wherein ‘N’ is the number of coverage areas. These communications services can include cellular services, wireless services such as RFID tracking, Wireless Fidelity (Wi-Fi), local area network (LAN), WLAN, and combinations thereof, as examples. The coverage areas 10(1)-10(N) may be remotely located. In this regard, the remote coverage areas 10(1)-10(N) are created by and centered on remote antenna units 14(1)-14(N) connected to a HEE 16 (e.g., a head-end controller or head-end unit or central unit). The HEE 16 may be communicatively coupled to a base station 18. In this regard, the HEE 16 receives downlink RF communications signals 20D from the base station 18 to be distributed to the remote antenna units 14(1)-14(N). The remote antenna units 14(1)-14(N) are configured to receive downlink communications signals 20D from the HEE 16 over a communications medium 22 to be distributed to the respective coverage areas 10(1)-10(N) of the remote antenna units 14(1)-14(N). Each remote antenna unit 14(1)-14(N) may include an RF transmitter/receiver (not shown) and a respective antenna 24(1)-24(N) operably connected to the RF transmitter/receiver to wirelessly distribute the communications services to client devices 26 within their respective coverage areas 10(1)-10(N). The remote antenna units 14(1)-14(N) are also configured to receive uplink RF communications signals 20U from the client devices 26 in their respective coverage areas 10(1)-10(N) to be distributed to the base station 18. The size of a given coverage area 10(1)-10(N) is determined by the amount of RF power transmitted by the respective remote antenna unit 14(1)-14(N), the receiver sensitivity, antenna gain and the RF environment, as well as by the RF transmitter/receiver sensitivity of the client device 26. Client devices 26 usually have a fixed maximum RF receiver sensitivity, so that the above-mentioned properties of the remote antenna units 14(1)-14(N) mainly determine the size of their respective remote coverage areas 10(1)-10(N).

To illustrate specific aspects related to an optical fiber-based DAS, FIG. 2A is a schematic diagram of an exemplary optical fiber-based DAS configured to provide a variety of wireless communications services to a plurality of RUs. In this embodiment, the optical fiber-based DAS 30 includes optical fiber for distributing RF communication services. The optical fiber-based DAS 30 in this embodiment is comprised of three (3) main components. One or more radio interfaces provided in the form of radio interface modules (RIMs) 32(1)-32(M) in this embodiment are provided in HEE 34 to receive and process downlink electrical RF communications signals 36D(1)-36D(R) from one or more wireless communications service providers (not shown) prior to optical conversion into downlink optical RF communications signals. The RIMs 32(1)-32(M) provide both downlink and uplink interfaces. The notations “1-R” and “1-M” indicate that any number of the referenced component, 1-R and 1-M, respectively, may be provided. As will be described in more detail below, the HEE 34 is configured to accept a plurality of RIMs 32(1)-32(M) as modular components that can easily be installed and removed or replaced in the HEE 34. In one embodiment, the HEE 34 is configured to support up to eight (8) RIMs 32(1)-32(8).

Each RIM 32(1)-32(M) can be designed to support a particular type of radio source or range of radio sources (i.e., frequencies) to provide flexibility in configuring the HEE 34 and the optical fiber-based DAS 30 to support the desired radio sources. For example, one RIM 32 may be configured to support the Personal Communication Services (PCS) radio band. Another RIM 32 may be configured to support the 700 MHz radio band. In this example, by inclusion of these RIMs 32, the HEE 34 would be configured to support and distribute RF communications signals on both PCS and LTE 700 radio bands. RIMs 32 may be provided in the HEE 34 that support any frequency bands desired, including but not limited to the US Cellular band, Personal Communication Services (PCS) band, Advanced Wireless Services (AWS) band, 700 MHz band, Global System for Mobile communications (GSM) 900, GSM 1800, and Universal Mobile Telecommunication System (UMTS). RIMs 32 may be provided in the HEE 34 that support any wireless technologies desired, including but not limited to Code Division Multiple Access (CDMA), CDMA200, 1×RTT, Evolution—Data Only (EV-DO), UMTS, High-speed Packet Access (HSPA), GSM, General Packet Radio Services (GPRS), Enhanced Data GSM Environment (EDGE), Time Division Multiple Access (TDMA), Long Term Evolution (LTE), iDEN, and Cellular Digital Packet Data (CDPD).

RIMs 32 may be provided in the HEE 34 that support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

The downlink electrical RF communications signals 36D(1)-36D(R) are provided to a plurality of optical interfaces provided in the form of optical interface modules (OIMs) 38(1)-38(N) in this embodiment to convert the downlink electrical RF communications signals 36D(1)-36D(R) into downlink optical RF communications signals 40D(1)-40D(R). The notation “1-N” indicates that any number of the referenced component 1-N may be provided. The OIMs 38 may be configured to provide one or more optical interface components (OICs) that contain optical-to-electrical (O/E) and electrical-to-optical (E/O) converters, as will be described in more detail below. The OIMs 38 support the radio bands that can be provided by the RIMs 32, including the examples previously described above. Thus, in this embodiment, the OIMs 38 may support a radio band range from 400 MHz to 2700 MHz, as an example, so providing different types or models of OIMs 38 for narrower radio bands to support possibilities for different radio band-supported RIMs 32 provided in the HEE 34 is not required. Further, as an example, the OIMs 38 may be optimized for sub-bands within the 400 MHz to 2700 MHz frequency range, such as 400-700 MHz, 700 MHz-1 GHz, 1 GHz-1.6 GHz, and 1.6 GHz-2.7 GHz, as examples.

The OIMs 38(1)-38(N) each include E/O converters (not shown) to convert the downlink electrical RF communications signals 36D(1)-36D(R) to downlink optical RF communications signals 40D(1)-40D(R). The downlink optical RF communications signals 40D(1)-40D(R) are communicated over downlink optical fiber(s) 43D to a plurality of remote units provided in the form of remote antenna units (RAUs) 42(1)-42(P). The notation “1-P” indicates that any number of the referenced component 1-P may be provided. O/E converters (not shown) provided in the RAUs 42(1)-42(P) convert the downlink optical RF communications signals 40D(1)-40D(R) back into downlink electrical RF communications signals 36D(1)-36D(R), which are provided over downlinks 44(1)-44(P) coupled to antennas 46(1)-46(P) in the RAUs 42(1)-42(P) to client devices 26 in the reception range of the antennas 46(1)-46(P).

E/O converters (not shown) are also provided in the RAUs 42(1)-42(P) to convert uplink electrical RF communications signals received from client devices 26 through the antennas 46(1)-46(P) into uplink optical RF communications signals 48U(1)-48U(R) to be communicated over uplink optical fibers 43U to the OIMs 38(1)-38(N). The OIMs 38(1)-38(N) include O/E converters (not shown) that convert the uplink optical RF communications signals 48U(1)-48U(R) into uplink electrical RF communications signals 50U(1)-50U(R) that are processed by the RIMs 32(1)-32(M) and provided as uplink electrical RF communications signals 52U(1)-52U(R).

FIG. 2B provides a simplified version of the optical fiber-based DAS in FIG. 2A showing a HEE communicatively coupled to a RU over an existing optical fiber communication medium. The simplified optical fiber-based DAS 60 includes a HEE 62, a RU 64, a downlink optical fiber 66, and an uplink optical fiber 68. The HEE 62 comprises a RIM 70 and an OIM 72. Like RIMs 32 in FIG. 2A, the RIM 70 is configured to receive and process downlink electrical RF communications signals 74 from one or more wireless communications service providers (not shown) prior to optical conversion into downlink optical RF communications signals. The RIM 70 provides both downlink and uplink interfaces. The downlink electrical RF communications signal 74 is provided to the OIM 72, which is the same as OIMs 38 in FIG. 2A, so as to convert the downlink electrical RF communications signal 74 into downlink optical RF communications signal 76. The OIM 72 supports the radio bands that can be provided by the RIM 70, including the examples previously described in FIG. 2A. The OIM 72 includes E/O converters (not shown) to convert the downlink electrical RF communications signal 74 to downlink optical RF communications signal 76. The downlink optical RF communications signal 76 is communicated over the downlink optical fiber 66 to the RU 64. O/E converters (not shown) provided in the RU 64 convert the downlink optical RF communications signal 76 back into the downlink electrical RF communications signal 74, which is provided over downlink 78 coupled to antenna 80 in the RU 64 for transmission to client devices (not shown) in the reception range of the antenna 80. E/O converters (not shown) are also provided in the RU 64 to convert uplink electrical RF communications signals received from client devices (not shown) through the antennas 80 into an uplink optical RF communications signal 82 to be communicated over the uplink optical fiber 68 to the OIM 72. The OIM 72 includes O/E converters (not shown) that convert the uplink optical RF communications signals 82 into the uplink electrical RF communications signal 84 that is processed by the RIM 70 and provided as the uplink electrical RF communications signal 84 to the one or more wireless communications service providers (not shown).

Although the RU 64 in the DAS 60 in FIG. 2B is designed to support a wide range of RF bands and wireless communication technologies, it may need to be upgraded over time to meet growing user demands for new wireless communications services and/or to improve existing wireless communications services (e.g., supporting new RF bands, increasing coverage, adding more bandwidth, etc.). As result, a new RU may need to be added to the DAS 60. As can be seen in FIG. 2B, a pair of dedicated downlink and uplink optical fibers 66, 68 are installed in the DAS 60 for communicating the downlink optical RF communications signals 76 and the uplink optical RF communications signals 82, respectively, between the OIM 72 and the RU 64. Accordingly, a new pair of downlink and uplink optical fibers would need to be installed in the DAS 60 for communicating new downlink and uplink optical RF communications signals associated with the new RU. Given the high deployment cost and service disruption associated with optical fiber installation, it is more desirable if the new RU could be added into the DAS 60 without adding new optical fibers.

In this regard, FIG. 3 is a schematic diagram of an exemplary upgraded optical fiber-based DAS 90 configured to support an add-on RU over the existing optical fiber communication medium using WDM. For the convenience of discussions in this disclosure, the terms “existing” and “add-on” are used in conjunction with references to a DAS or a DAS element. For example, an existing DAS, an existing RU, an add-on RU, and so on. The term “existing” distinctively indicates a system or an element that has already been installed and functional. An “existing” system or element may not be removed, but may be reconfigured or modified to work with an “add-on” system or element. The term “add-on” distinctively indicates a new system or a new element that is added to the installed DAS for enabling new wireless communications services and/or improving existing wireless communications services.

In FIG. 3, the upgraded optical fiber-based DAS 90 comprises an existing HEE 92 and an existing RU system 94. The existing HEE 92 comprises an existing RIM 96 and an existing OIM 98. The existing RIM 96 and the existing OIM 98 provide an existing downlink communications signal path for the HEE 92. The existing RIM 96 is configured to receive and process at least one existing downlink electrical RF communications signal 100 (a first downlink RF communications signal) from one or more wireless communications service providers (not shown) prior to optical conversion into at least one existing downlink optical RF communications signal 102 (a first downlink optical signal). The existing RIM 96 provides both downlink and uplink interfaces. The existing downlink electrical RF communications signal 100 is provided to a first downlink electrical RF signal interface 101 and received by the existing OIM 98 so as to convert the existing downlink electrical RF communications signal 100 into the existing downlink optical RF communications signal 102. The existing OIM 98 includes E/O converters (not shown) to convert the existing downlink electrical RF communications signal 100 into the existing downlink optical RF communications signal 102. The existing downlink optical RF communications signal 102 is provided to at least one first downlink optical signal interface 103. To enable an add-on RF band and/or wireless communications service, an add-on RIM 104 and an add-on OIM 106 are added to the existing HEE 92. The add-on RIM 104 and the add-on OIM 106 provide an add-on downlink communications signal path for the HEE 92. Similarly, the add-on RIM 104 is configured to receive and process at least one add-on downlink electrical RF communications signal 108 (a second downlink RF communications signal) from one or more wireless communications service providers (not shown) prior to optical conversion into at least add-on downlink optical RF communications signal 110 (a second downlink optical signal). The add-on RIM 104 also provides both downlink and uplink interfaces. The add-on downlink electrical RF communications signal 108 is provided to at least one second downlink electrical RF signal interface 109 and received by the add-on OIM 106 so as to convert the add-on downlink electrical RF communications signal 108 into the add-on downlink optical RF communications signal 110. The add-on OIM 106 includes E/O converters (not shown) to convert the add-on downlink electrical RF communications signal 108 to the add-on downlink optical RF communications signal 110. The add-on downlink optical RF communications signal 110 is provided to a second downlink optical signal interface 111.

In order to transmit both the existing downlink optical RF communications signal 102 and the add-on downlink optical RF communications signal 110 over an existing downlink optical fiber 112, a HEE multiplexing/de-multiplexing (mux/demux) circuit 114 is provided in the existing HEE 92. The HEE mux/demux circuit 114 wavelength division multiplexes the existing downlink optical RF communications signal 102 and the add-on downlink optical RF communications signal 110 into a downlink wavelength division multiplexing (WDM) optical signal 116. The downlink WDM optical signal 116 is communicated over the existing downlink optical fiber 112 to the existing RU system 94. In this manner, the existing downlink optical RF communications signal 102 and the add-on downlink optical RF communications signal 110 can be transmitted over the same downlink optical fiber.

With continuing reference to FIG. 3, a RU mux/demux circuit 118 is provided in the existing RU system 94 and configured to receive the downlink WDM optical signal 116 over the existing downlink optical fiber 112. The RU mux/demux circuit 118 wavelength division de-multiplexes the downlink WDM optical signal 116 back to the existing downlink optical RF communications signal 102 and the add-on downlink optical RF communications signal 110. The existing downlink optical RF communications signal 102 is provided to an existing RU 120 via a first RU downlink optical signal interface 119. An add-on RU 122 is added to the existing RU system 94 for receiving the add-on downlink optical RF communications signal 110 from a second RU downlink optical signal interface 121. O/E converters (not shown) are provided in the existing RU 120 and the add-on RU 122 to convert the existing downlink optical RF communications signal 102 and the add-on downlink optical RF communications signal 110 back into the existing downlink electrical RF communications signal 100 and the add-on downlink electrical RF communications signal 108, respectively. The existing downlink electrical RF communications signal 100 and the add-on downlink electrical RF communications signal 108 are provided to at least one antenna (not shown) in the existing RU system 94 for transmission to client devices (not shown). In this regard, the RU mux/demux circuit 118 and the existing RU 120 provide an existing RU downlink communications signal path in the RU system 94. Similarly, the RU mux/demux circuit 118 and the add-on RU 122 provide an add-on RU downlink communications signal path in the RU system 94.

For the uplink path, E/O converters (not shown) are also provided in the existing RU 120 and the add-on RU 122 to convert uplink electrical RF communications signals 99 and 107 received from client devices (not shown) through the at least one antenna (not shown) into an existing uplink optical RF communications signal 124 and an add-on uplink optical RF communications signal 126, respectively. The existing uplink optical RF communications signal 124 and the add-on uplink optical RF communications signal 126 are provided to a first RU uplink optical signal interface 125 and a second RU uplink optical signal interface 127, respectively. The existing uplink optical RF communications signal 124 and the add-on uplink optical RF communications signal 126 are wavelength division multiplexed by the RU mux/demux circuit 118 into an uplink WDM optical signal 128 and communicated over an existing uplink optical fiber 130 to the HEE mux/demux circuit 114. In this regard, the RU mux/demux circuit 118 and the existing RU 120 further provide an existing RU uplink communications signal path in the RU system 94. Similarly, the RU mux/demux circuit 118 and the add-on RU 122 further provide an add-on RU uplink communications signal path in the RU system 94. The HEE mux/demux circuit 114 wavelength division de-multiplexes the uplink WDM optical signal 128 into an existing uplink optical RF communications signal 124 and an add-on uplink optical RF communications signal 126. The existing uplink optical RF communications signal 124 is provided to at least one first uplink optical signal interface 131 and the add-on uplink optical RF communications signal 126 is provided to a second uplink optical signal interface 133. The existing OIM 98 includes O/E converters (not shown) that convert the existing uplink optical RF communications signal 124 into an existing uplink electrical RF communications signal 136. The existing uplink electrical RF communications signal 136 is provided to a first uplink electrical RF signal interface 132. The existing uplink electrical RF communications signal 136 is received and processed by the existing RIM 96 and provided as the existing uplink electrical RF communications signal 136 to the one or more wireless communications service providers (not shown). The add-on OIM 106 also includes O/E converters (not shown) that convert the add-on uplink optical RF communications signal 126 into an add-on uplink electrical RF communications signal 138. The add-on uplink electrical RF communications signal 138 is provided to at least one second uplink electrical RF signal interface 134. The add-on uplink electrical RF communications signal 138 is received and processed by the add-on RIM 104 and provided as the add-on uplink electrical RF communications signal 138 to the respective one or more wireless communications service providers (not shown). The existing OIM 98 and the existing RIM 96 provide an existing uplink communications signal path. Similarly, the add-on OIM 106 and the add-on RIM 104 provide an add-on uplink communications signal path By including the HEE mux/demux circuit 114 and the RU mux/demux circuit 118 in the existing HEE 92 and the existing RU system 94, respectively, the add-on RU 122 can be added to support add-on RF bands and/or wireless communications services without the need to deploy new optical fibers.

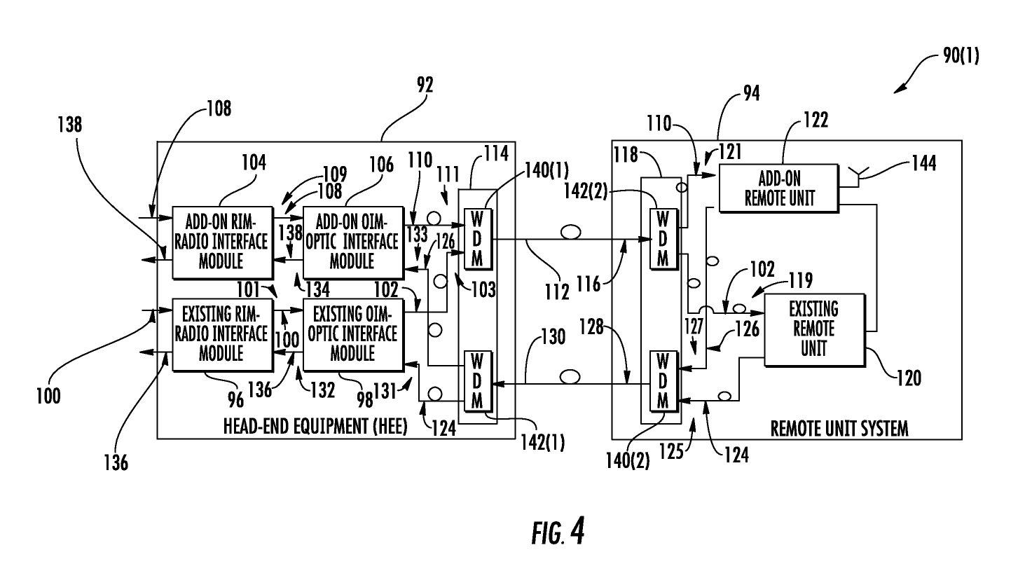

In this regard, FIG. 4 is a schematic diagram of an exemplary configuration of an existing RU system 94 in an upgraded DAS 90(1) for supporting an add-on RU 122. Many elements and signals in FIG. 4 are common to the counterparts in FIG. 3 and thus will not be re-described herein. FIG. 4 provides an upgraded optical fiber-based DAS 90(1) comprising the existing HEE 92 and the existing RU system 94. Similarly, the existing HEE 92 has the HEE mux/demux circuit 114 and the existing RU system 94 has the RU mux/demux circuit 118. In a non-limiting example, the HEE mux/demux circuit 114 comprises a WDM multiplexer 140(1) and a WDM de-multiplexer 142(1). The WDM multiplexer 140(1) is configured to wavelength division multiplex the existing downlink optical RF communications signal 102 and the add-on downlink optical RF communications signal 110 into the downlink WDM optical signal 116. The WDM de-multiplexer 142(1) is configured to wavelength division de-multiplex the uplink WDM optical signal 128 into the existing uplink optical RF communications signal 124 and the add-on uplink optical RF communications signal 126. In another non-limiting example, the RU mux/demux circuit 118 comprises a WDM multiplexer 140(2) and a WDM de-multiplexer 142(2). The WDM de-multiplexer 142(2) is configured to wavelength division de-multiplex the downlink WDM optical signal 116 into the existing downlink optical RF communications signal 102 and the add-on downlink optical RF communications signal 110. The WDM multiplexer 140(2) is configured to wavelength division multiplex the existing uplink optical RF communications signal 124 and the add-on uplink optical RF communications signal 126 into the uplink WDM optical signal 128. According to an exemplary illustration in FIG. 4, the existing RU 120 and the add-on RU 122 are configured to share an antenna 144. However, such antenna configuration is not mandated in order to support the add-on RU 122 in the existing optical fiber-based DAS 90(1).

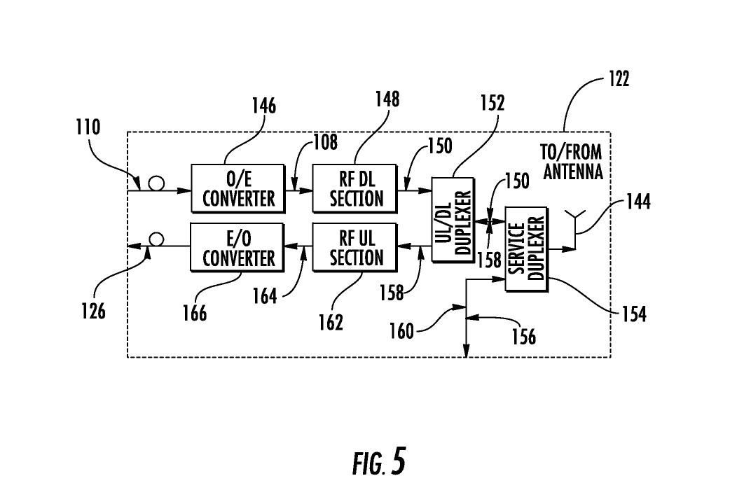

To illustrate the internal structure of the add-on RU 122 that shares the antenna 144 with the existing RU 120 shown in FIG. 4, FIG. 5 is provided. FIG. 5 is an exemplary schematic diagram of an add-on RU that shares an antenna with an existing RU. Elements of FIGS. 3 and 4 are referenced in connection with FIG. 5 and will not be re-described herein. On the downlink communications signal path, the add-on RU 122 comprises an O/E converter 146, which converts the add-on downlink optical RF communications signal 110 into the add-on downlink electrical RF communications signal 108. The add-on downlink electrical RF communications signal 108 is further processed by a RF downlink section 148 and turned into an add-on downlink RF signal 150. An uplink/downlink duplexer 152 provides the add-on downlink RF signal 150 to a service duplexer 154, which in turn couples the add-on downlink RF signal 150 with the antenna 144 for over-the-air (OTA) transmission. The service duplexer 154 is also configured to receive an existing downlink RF signal 156 from the existing RU 120 (not shown). In this regard, the service duplexer 154 serves as a RF switch that alternately couples the add-on downlink RF signal 150 and the existing downlink RF signal 156 with the antenna 144 for OTA downlink transmissions. On the uplink communications signal path, the service duplexer 154 alternately provides an add-on uplink RF signal 158 and an existing uplink RF signal 160 to the uplink/downlink duplexer 152 and the existing RU 120, respectively. The uplink/downlink duplexer 152, which alternates between the add-on downlink RF signal 150 and the add-on uplink RF signal 158, in turn provides the add-on uplink RF signal 158 to an RF uplink section 162. The add-on uplink RF signal 158 is further processed at the RF uplink section 162 and turned into an add-on uplink electrical RF communications signal 164. The add-on uplink electrical RF communications signal 164 is then provided to an E/O converter 166 for converting to the add-on uplink optical RF communications signal 126.

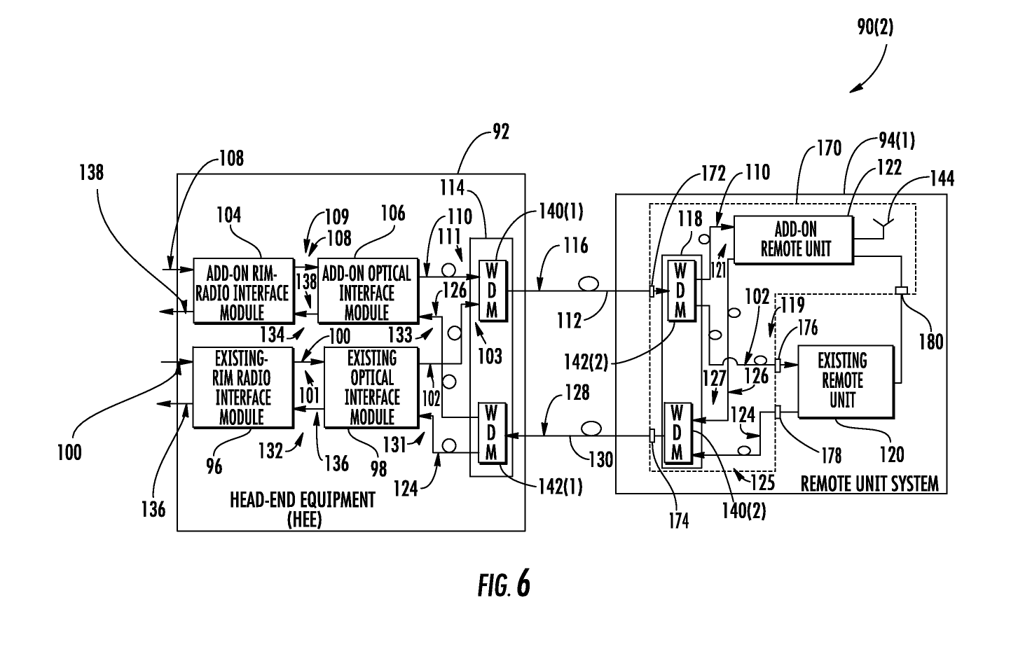

As previously discussed in FIG. 4, the RU mux/demux circuit 118 may be provided in the existing RU system 94 as a separate entity. Alternatively, the RU mux/demux circuit 118 may also be integrated or packaged with the add-on RU 122. In this regard, FIG. 6 is a schematic diagram of an exemplary configuration to support an add-on RU in an existing optical fiber-based DAS using a wavelength division mux/demux circuit integrated or packaged with the add-on RU 122. Many elements and signals in FIG. 6 are common to the counterparts in FIG. 4 and thus will not be re-described herein.

FIG. 6 provides an existing optical fiber-based DAS 90(2). The existing optical fiber-based DAS 90(2) has an existing RU system 94(1) that comprises a combined add-on RU 170. The combined add-on RU 170 comprises the add-on RU 122 and the RU mux/demux circuit 118. In a non-limiting example, the RU mux/demux circuit 118 and the add-on RU 122 are completely enclosed in the combined add-on RU 170, thus becoming indistinguishable from the outside. To facilitate installation and configuration, the combined add-on RU 170 is designed to provide a downlink WDM optical signal port 172, an uplink WDM optical signal port 174, a downlink optical RF communications signal port 176, an uplink optical RF communications signal port 178, and an antenna port 180. The downlink WDM optical signal port 172 is connected to the existing downlink optical fiber 112 for receiving the downlink WDM optical signal 116. The uplink WDM optical signal port 174 is connected to the existing uplink optical fiber 130 for communicating the uplink WDM optical signal 128. The downlink optical RF communications signal port 176 and the uplink optical RF communications signal port 178 are designed to conveniently connect the existing RU 120 for communicating the existing downlink optical RF communications signal 102 and receiving the existing uplink optical RF communications signal 124, respectively. The antenna port 180 is provided to allow the add-on RU 122 and the existing RU 120 to conveniently share the antenna 144.

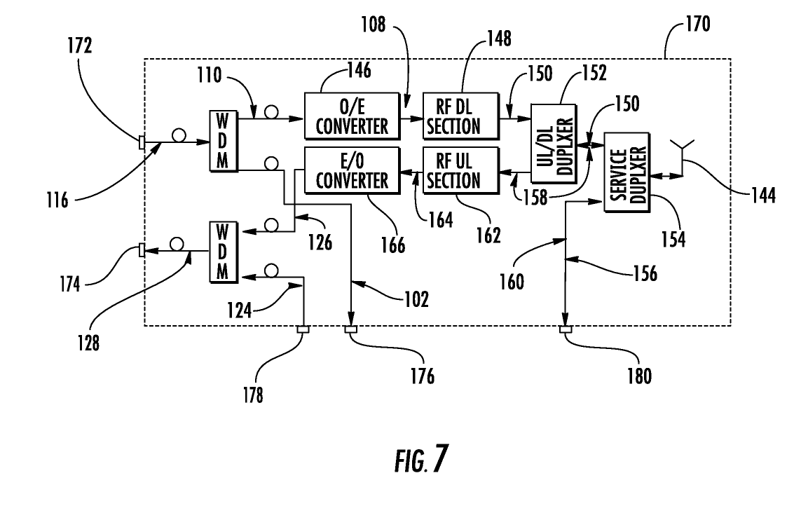

FIG. 7 is a schematic diagram of an exemplary combined add-on RU of FIG. 6 that shares an antenna with an existing RU. In this regard, FIG. 7 provides an illustration of the combined add-on RU 170 of FIG. 6 and the internal configuration of the add-on RU 122 of FIG. 5. All of the elements and signals in FIG. 7 have been respectively introduced in reference to FIGS. 5 and 6, and thus will not be re-described herein for the sake of conciseness.

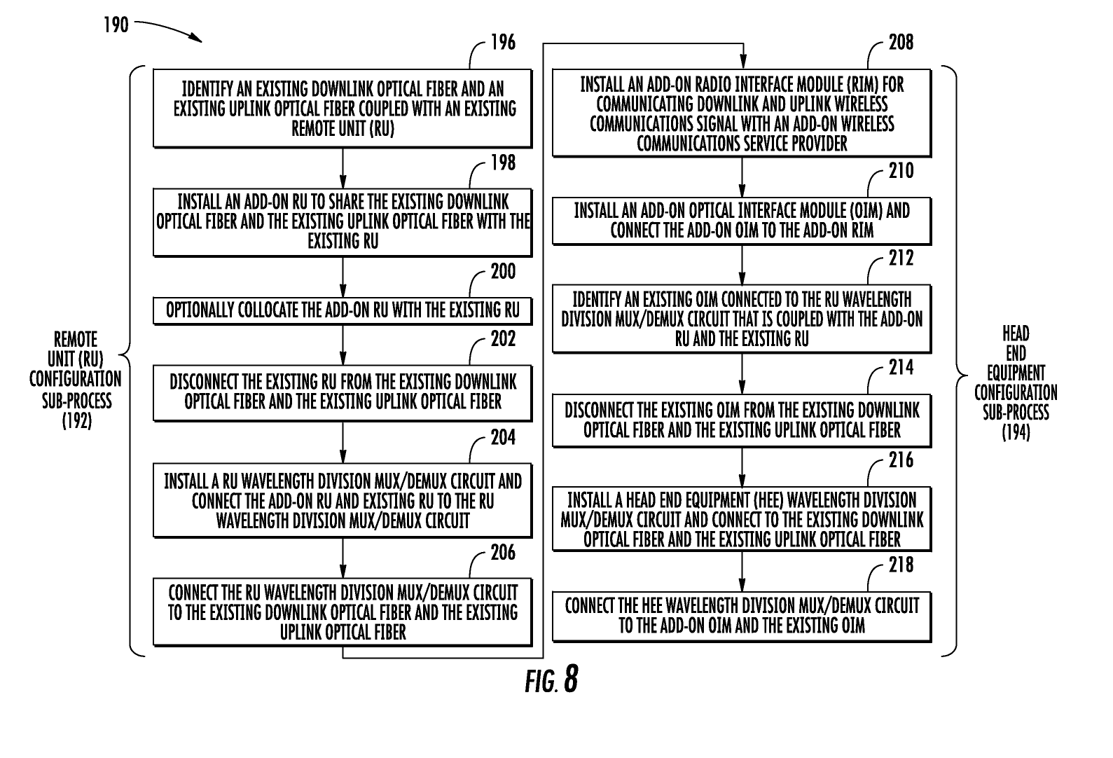

To upgrade the optical fiber-based DAS 90 in FIG. 3, FIG. 8 is a flowchart of an exemplary configuration process for upgrading an optical fiber-based DAS to support an add-on RU over the existing optical fiber communication medium using WDM. The configuration process 190 comprises a RU configuration sub-process 192 and a HEE configuration sub-process 194. The RU configuration sub-process 192 first identifies an existing downlink optical fiber and an existing uplink optical fiber that are to be shared for supporting an add-on RU using WDM (block 196). Once the existing downlink optical fiber and the existing uplink optical fiber are identified, an existing RU that is coupled to the existing downlink optical fiber and the existing uplink optical fiber can also be identified. An add-on RU is then installed to share the existing downlink optical fiber and the existing uplink optical fiber with the existing RU (block 198). Optionally, the add-on RU may be collocated with the existing RU (block 200). The existing RU is then disconnected from the existing downlink optical fiber and the existing uplink optical fiber (block 202). A RU wavelength division mux/demux circuit is in turn installed and connected to the existing RU and the add-on RU (block 204). The RU wavelength division mux/demux circuit is reconnected with the existing downlink optical fiber and the existing uplink optical fiber (block 206). In the HEE configuration sub-process 194, an add-on RIM may be installed to enable wireless communications services with an add-on wireless communications service provider (block 208). This step is not always necessary because an existing RIM may also be upgraded or reconfigured as an alternative to adding the add-on RIM under certain circumstances. An add-on OIM is installed and connected to the add-on RIM (block 210). In order to share the existing downlink optical fiber and the existing uplink optical fiber that have been identified in the RU configuration sub-process 192, an existing OIM in the HEE that connects to RU wavelength division multiplexer circuit that is coupled with the add-on RU and the existing RU (block 212). The existing OIM is then disconnected from the existing downlink optical fiber and the existing uplink optical fiber (block 214). A HEE wavelength division mux/demux circuit is installed and connected to the existing downlink optical fiber and the existing uplink optical fiber (block 216). Finally, the HEE wavelength division mux/demux circuit is connected to the existing OIM and the add-on OIM (block 218).

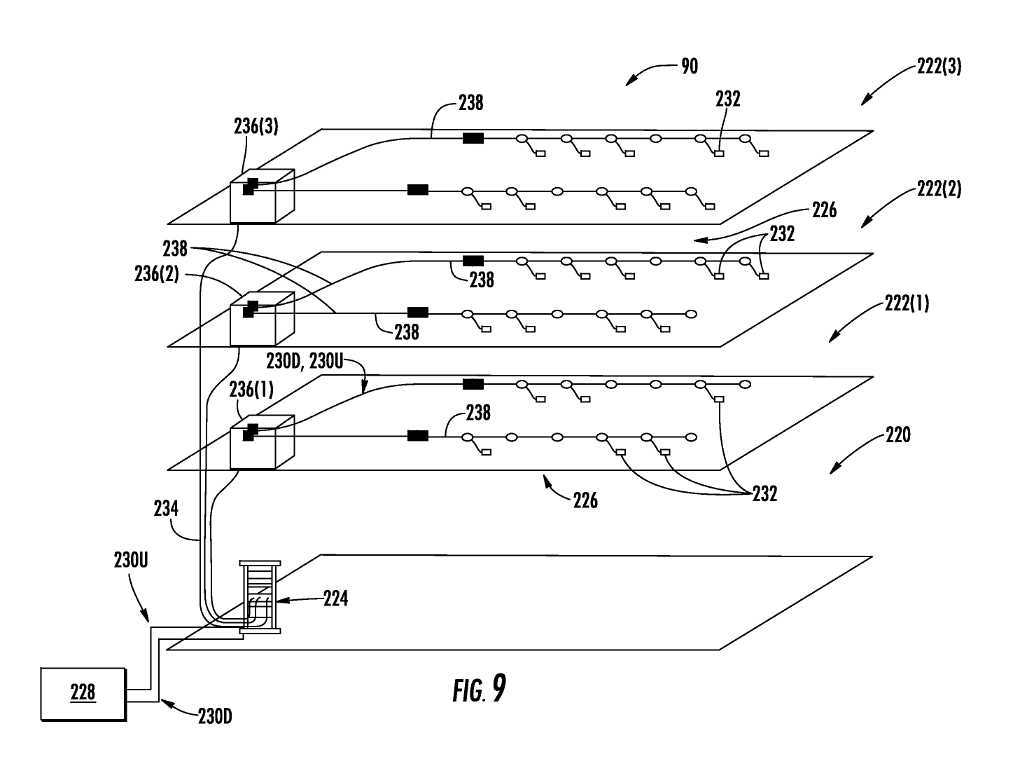

The DAS 90 in FIGS. 3 and 4 may be provided in an indoor environment, as illustrated in FIG. 9. FIG. 9 is a partially schematic cut-away diagram of an exemplary building infrastructure in which the upgraded optical fiber-based DAS in FIGS. 3 and 4 can be employed. The building infrastructure 220 in this embodiment includes a first (ground) floor 222(1), a second floor 222(2), and a third floor 222(3). The floors 222(1)-222(3) are serviced by the central unit 224 to provide the antenna coverage areas 226 in the building infrastructure 220. The central unit 224 is communicatively coupled to the base station 228 to receive downlink communications signals 230D from the base station 228. The central unit 224 is communicatively coupled to the remote antenna units 232 to receive the uplink communications signals 230U from the remote antenna units 232, as previously discussed above. The downlink and uplink communications signals 230D, 230U communicated between the central unit 224 and the remote antenna units 232 are carried over a riser cable 234. The riser cable 234 may be routed through interconnect units (ICUs) 236(1)-236(3) dedicated to each floor 222(1)-222(3) that route the downlink and uplink communications signals 230D, 230U to the remote antenna units 232 and also provide power to the remote antenna units 232 via array cables 238.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An upgraded head end equipment (HEE) in an optical fiber-based distributed antenna system (DAS), comprising:
an existing downlink communications signal path configured to receive and convert at least one first downlink radio frequency (RF) communications signal into at least one first downlink optical signal;
an add-on downlink communications signal path configured to receive and convert at least one second downlink RF communications signal different from the at least one first downlink RF communications signal into at least one second downlink optical signal; and
a HEE wavelength division multiplexer coupled to a downlink optical fiber, the HEE wavelength division multiplexer configured to:
receive the at least one first downlink optical signal from the existing downlink communications signal path via at least one first downlink optical signal interface;
receive the at least one second downlink optical signal from the add-on downlink communications signal path via at least one second downlink optical signal interface;
wavelength division multiplex (WDM) the at least one first downlink optical signal and the at least one second downlink optical signal and generate a downlink WDM optical signal; and
provide the downlink WDM optical signal to the downlink optical fiber.

2. The upgraded HEE of claim 1, further comprising:
an existing uplink communications signal path configured to receive and convert at least one first uplink optical signal into at least one first uplink RF communications signal;
an add-on uplink communications signal path configured to receive and convert at least one second uplink optical signal into at least one second uplink RF communications signal; and
a HEE wavelength division de-multiplexer coupled to an uplink optical fiber, the HEE wavelength division de-multiplexer configured to:
receive an uplink WDM optical signal from the uplink optical fiber;
wavelength division de-multiplex the uplink WDM optical signal and generate the at least one first uplink optical signal and the at least one second uplink optical signal;
provide the at least one first uplink optical signal to the existing uplink communications signal path via at least one first uplink optical signal interface; and
provide the at least one second uplink optical signal to the add-on uplink communications signal path via at least one second uplink optical signal interface.

3. The upgraded HEE of claim 2, wherein:
the existing downlink communications signal path further comprises:
at least one existing radio interface module (RIM) configured to receive the at least one first downlink RF communications signal from at least one first wireless communications service provider and provide the at least one first downlink RF communications signal to at least one first downlink electrical RF signal interface; and
at least one existing optical interface module (OIM) configured to:
receive at least one first downlink electrical RF communications signal from the at least one first downlink electrical RF signal interface;
convert the at least one first downlink electrical RF communications signal to at least one first downlink optical signal; and
provide the at least one first downlink optical signal to the at least one first downlink optical signal interface; and
the add-on downlink communications signal path further comprises:
at least one add-on RIM configured to receive the at least one second downlink RF communications signal from at least one second wireless communications service provider and provide the at least one second downlink RF communications signal to at least one second downlink electrical RF signal interface; and
at least one add-on OIM configured to:
receive at least one second downlink electrical RF communications signal from the at least one second downlink electrical RF signal interface;
convert the at least one second downlink electrical RF communications signal to at least one second downlink optical signal; and
provide the at least one second downlink optical signal to the at least one second downlink optical signal interface.

4. The upgraded HEE of claim 3, wherein:
the existing uplink communications signal path comprises:
the at least one existing OIM configured to:
receive at least one first uplink optical signal from the at least one first uplink optical signal interface;
convert the at least one first uplink optical signal to at least one first uplink electrical RF communications signal; and
provide the at least one first uplink electrical RF communications signal to at least one first uplink electrical RF signal interface; and
the at least one existing RIM configured to receive the at least one first uplink electrical RF communications signal from the at least one first uplink electrical RF signal interface and provide the at least one first uplink electrical RF communications signal to the at least one first communications service provider; and
the add-on uplink communications signal path comprises:
the at least one add-on OIM configured to:
receive at least one second uplink optical signal from the at least one second uplink optical signal interface;
convert the at least one second uplink optical signal to at least one second uplink electrical RF communications signal; and
provide the at least one second uplink electrical RF communications signal to at least one second uplink electrical RF signal interface; and
the at least one add-on RIM configured to receive the at least one second uplink electrical RF communications signal from the at least one second uplink electrical RF signal interface and provide the at least one second uplink electrical RF communications signal to the at least one second communications service provider.

5. The upgraded HEE of claim 2, wherein the HEE wavelength division multiplexer and the HEE wavelength division de-multiplexer are integrated into an integrated HEE wavelength division multiplexing/de-multiplexing (mux/demux) circuit.

6. An upgraded remote unit (RU) system in an optical fiber-based distributed antenna system (DAS), comprising:
an existing RU downlink communications signal path configured to receive and convert at least one first downlink optical signal into at least one first downlink electrical radio frequency (RF) communications signal;
an add-on RU downlink communications signal path configured to receive and convert at least one second downlink optical signal into at least one second downlink electrical RF signal different from the at least one first downlink electrical RF communications signal; and
a RU wavelength division de-multiplexer coupled to a downlink optical fiber, the RU wavelength division de-multiplexer configured to:
receive a downlink wavelength division multiplexing (WDM) optical signal from the downlink optical fiber coupled to a head end equipment (HEE) wavelength division multiplexer in at least one HEE;
wavelength division de-multiplex the downlink WDM optical signal and generate the at least one first downlink optical signal and the at least one second downlink optical signal;
provide the at least one first downlink optical signal to the existing RU downlink communications signal path via at least one first RU downlink optical signal interface; and
provide the at least one second downlink optical signal to the add-on RU downlink communications signal path via at least one second RU downlink optical signal interface.

7. The upgraded RU system of claim 6, further comprising:
an existing RU uplink communications signal path configured to receive and convert at least one first uplink electrical RF communications signal into at least one first uplink optical signal;
an add-on RU uplink communications signal path configured to receive and convert at least one second uplink electrical RF communications signal different from the at least one first uplink electrical RF communications signal into at least one second uplink optical signal; and
a RU wavelength division multiplexer coupled to an uplink optical fiber, the RU wavelength division multiplexer configured to:
receive the at least one first uplink optical signal from the existing RU uplink communications signal path from at least one first RU uplink optical signal interface;
receive the at least one second uplink optical signal from the add-on RU uplink communications signal path from at least one second RU uplink optical signal interface;
wavelength division multiplex the at least one first uplink optical signal and the at least one second uplink optical signal and generate an uplink WDM optical signal; and
provide the uplink WDM optical signal to the uplink optical fiber.

8. The upgraded RU system of claim 7, wherein:
the existing RU downlink communications signal path further comprises at least one existing RU, the at least one existing RU configured to:
receive the at least one first downlink optical signal from the at least one first RU downlink optical signal interface;
convert the at least one first downlink optical signal to at least one first downlink RF signal; and
provide the at least one first downlink RF signal to at least one existing antenna; and
the add-on RU downlink communications signal path further comprises at least one add-on RU, the at least one add-on RU configured to:
receive the at least one second downlink optical signal from the at least one second RU downlink optical signal interface;
convert the at least one second downlink optical signal to at least one second downlink RF signal; and
provide the at least one second downlink RF signal to at least one add-on antenna.

9. The upgraded RU system of claim 8, wherein:
the existing RU uplink communications signal path further comprises the at least one existing RU, the at least one existing RU configured to:
receive at least one first uplink RF signal from the at least one existing antenna;
convert the at least one first uplink RF signal to at least one first uplink optical signal; and
provide the at least one first uplink optical signal to the at least one first RU uplink optical signal interface; and
the add-on RU uplink communications signal path further comprises the at least one add-on RU, the at least one add-on RU configured to:
receive at least one second uplink RF signal from the at least one add-on antenna;
convert the at least one second uplink RF signal to at least one second uplink optical signal; and
provide the at least one second uplink optical signal to the at least one second RU uplink optical signal interface.

10. The upgraded RU system of claim 7, wherein the RU wavelength division multiplexer and the RU wavelength division de-multiplexer are integrated into an integrated RU wavelength division multiplexing/de-multiplexing (mux/demux) circuit.

11. The upgraded RU system of claim 10, wherein the RU wavelength division multiplexer and the RU wavelength division de-multiplexer are integrated into the at least one add-on RU to form at least one integrated add-on RU.

12. The upgraded RU system of claim 11, wherein the at least one integrated add-on RU comprises:
a downlink WDM optical signal port configured to receive the downlink WDM optical signal from the downlink optical fiber;
an uplink WDM optical signal port configured to provide the uplink WDM optical signal to the uplink optical fiber;
at least one downlink optical RF communications signal port configured to provide the at least one first downlink optical signal to the at least one existing RU;
at least one uplink optical RF communications signal port configured to receive the at least one first uplink optical signal from the at least one existing RU; and
at least one antenna port configured to:
receive the at least one first downlink RF signal from the at least one existing RU; and
provide the at least one first uplink RF signal to the at least one existing RU.

13. An upgraded optical fiber-based distributed antenna system (DAS), comprising:
a head end equipment (HEE), further comprising:
at least one existing radio interface module (RIM);
at least one existing optical interface module (OIM) coupled to the at least one existing RIM;
at least one add-on RIM;
at least one add-on OIM coupled to the at least one add-on RIM;
a HEE wavelength division multiplexing/de-multiplexing (mux/demux) circuit coupled to the at least one existing OIM and the at least one add-on OIM; and
wherein the HEE wavelength division mux/demux circuit further comprises:
a HEE wavelength division multiplexer; and
a HEE wavelength division de-multiplexer;
a remote unit (RU) system, further comprising:
at least one existing RU;
at least one add-on RU;
a RU wavelength division mux/demux circuit coupled to the at least one existing RU and the at least one add-on RU; and
wherein the RU wavelength division mux/demux circuit further comprises:
a RU wavelength division multiplexer; and
a RU wavelength division de-multiplexer;
at least one downlink optical fiber connecting the HEE wavelength division multiplexer to the RU wavelength division de-multiplexer; and
at least one uplink optical fiber connecting the RU wavelength division multiplexer to the HEE wavelength division de-multiplexer.

14. The upgraded optical fiber-based DAS of claim 13, wherein the at least one add-on RU comprises at least one add-on antenna, wherein the at least one existing RU is configured to share the at least one add-on antenna associated with the at least one add-on RU.

15. The upgraded optical fiber-based DAS of claim 14, wherein the at least one existing RU comprises at least one existing antenna, wherein the at least one add-on RU is configured to share the at least one existing antenna associated with the at least one existing RU.

16. A method for adding an add-on remote unit (RU) in an existing distributed antenna system (DAS), comprising:
upgrading an existing RU system in the existing DAS, further comprising:
providing an add-on RU configured to:
receive an add-on downlink wireless communications signal for an add-on wireless communications service over an existing downlink optical fiber coupled to an existing RU, the existing RU configured to receive an existing downlink wireless communications signal for an existing wireless communications service over the existing downlink optical fiber; and
provide an add-on uplink wireless communications signal for the add-on wireless communications service over an existing uplink optical fiber coupled to the existing RU, the existing RU configured to provide an existing uplink wireless communications signal for the existing wireless communications service over the existing uplink optical fiber;
disconnecting the existing downlink optical fiber and the existing uplink optical fiber from the existing RU;
installing a RU wavelength division multiplexing/de-multiplexing (mux/demux) circuit;
connecting the add-on RU and the existing RU to the RU wavelength division mux/demux circuit; and
connecting the RU wavelength division mux/demux circuit to the existing downlink optical fiber and the existing uplink optical fiber; and
upgrading an existing head end equipment (HEE) in the existing DAS, further comprising:
providing an add-on radio interface module (RIM) configured to:
receive the add-on downlink wireless communications signal from an add-on wireless communications service provider for the add-on wireless communications service; and
provide the add-on uplink wireless communications signal to the add-on wireless communications service provider for the add-on wireless communications service;
providing an add-on optical interface module (OIM) and connecting the add-on OIM to the add-on RIM;
identifying an existing OIM coupled to the existing downlink optical fiber and the existing uplink optical fiber, the existing downlink optical fiber and the existing uplink optical fiber connect to the RU wavelength division mux/demux circuit;
disconnecting the existing OIM from the existing downlink optical fiber and the existing uplink optical fiber;
installing a HEE wavelength division mux/demux circuit;
connecting the add-on OIM and the existing OIM to the HEE wavelength division mux/demux circuit; and
connecting the HEE wavelength division mux/demux circuit to the existing downlink optical fiber and the existing uplink optical fiber.

17. The method of claim 16, comprising:
identifying the existing RU in the existing RU system for collocating with the add-on RU; and
collocating the add-on RU with the existing RU; and
identifying the existing downlink optical fiber and the existing uplink optical fiber that connect the existing RU to the existing OIM in the existing HEE of the existing DAS.

18. The method of claim 16, comprising:
reconfiguring an existing RIM to:
receive the add-on downlink wireless communications signal from the add-on wireless communications service provider for the add-on wireless communications service; and
provide the add-on uplink wireless communications signal to the add-on wireless communications service provider for the add-on wireless communications service; and
connecting the add-on OIM to the existing RIM.

19. The method of claim 16, further comprising integrating the RU wavelength division mux/demux circuit with the add-on RU.
